(19) United States
(12) Patent Application Publication
(10) Pub. No.: US 2025/0313340 A1
(43) Pub. Date: Oct. 9, 2025

(54) AIRCRAFT CONTROL SYSTEM

(71) Applicants: AIRBUS OPERATIONS LIMITED, Bristol (GB); AIRBUS OPERATIONS (S.A.S.), Toulouse Cedex 09 (FR); AIRBUS OPERATIONS S.L., Madrid (ES)

(72) Inventors: Andrew BILL, Bristol (GB); George HOWELL, Bristol (GB); Laura CAPELLERAS MAGANA, Toulouse Cedex 09 (FR); Asier Perez ETXEBARRIA, Madrid (ES)

(21) Appl. No.: 19/170,698

(22) Filed: Apr. 4, 2025

(30) Foreign Application Priority Data
Apr. 5, 2024 (GB) 2404933.0

(51) Int. Cl. B64D 27/35; H02J 4/00

(52) U.S. Cl. CPC B64D 27/35; H02J 4/00; B64D 2221/00; H02J 2310/44

(57) ABSTRACT

An aircraft control system and method for controlling electrical power distribution in an aircraft are disclosed. The aircraft control system and method obtain state signals from electrical systems in the aircraft, control characteristics of a power source, and control characteristics of the electrical systems. The control characteristics of the electrical systems are dependent on a flight phase status of the aircraft. Output control data is generated, based on the control characteristics and state signals, and used to control electrical power distribution in the aircraft.

### CROSS RELATED APPLICATION

This application claims priority to United Kingdom Patent Application GB 2404933.0, filed Apr. 5, 2024, the entire contents of which is hereby incorporated by reference.

### TECHNICAL FIELD

The present disclosure relates to controlling electrical power distribution in an aircraft.

### BACKGROUND

Modern aircraft rely on electrical power for a wide range of functions, such as avionics, lighting, environmental control, entertainment systems, braking control, and fuel systems. Traditionally, electrical power generation within an aircraft is provided by engine-driven generators and auxiliary power units (APUs). This power is then converted and distributed throughout the aircraft using a centralized approach.

### SUMMARY

According to a first aspect of the present disclosure, there is provided an aircraft control system configured to control electrical power distribution for a plurality of electrical systems in an aircraft, the aircraft control system comprising a control module that is configured to: obtain state signals from the plurality of electrical systems and a power source; obtain a control characteristic of each of the plurality of electrical systems, wherein the control characteristic of a said electrical system is dependent on a flight phase status of the aircraft; obtain a control characteristic of the power source; generate output control data based on the control characteristics of each of the plurality of electrical systems, the control characteristic of the power source, and the state signals; and control electrical power distribution in the aircraft based on the output control data.

Controlling electrical power distribution in an aircraft may generally involve controlling switches, generators, batteries, and other electrical componentry to deliver electrical power to one or more electrical systems in an aircraft. Aircraft may include a large number of aircraft systems which are used to power a variety of equipment from air conditioning and environmental control systems to avionic and flight control systems for flying the aircraft. Determining control characteristics for electrical systems in an aircraft that are dependent on a current flight phase of the aircraft, and controlling electrical power distribution based on these control characteristics, enables the aircraft control system to control electrical power distribution more efficiently and with greater flexibility than other aircraft control systems. In particular, by identifying whether the control characteristics of a given electrical system, such as power consumption and/or priority of power supply, vary in different flight phases it becomes possible to modify the amount of electrical power provided to certain electrical systems reliably and without affecting the reliability of the aircraft. In some cases, the increased flexibility in electrical power distribution may also enable the aircraft control system to increase or maintain power supply for electrical systems having a higher priority in any particular flight phase.

The state signals may represent an operational state of the plurality of electrical systems and the at least one power source. Obtaining the control characteristics of the plurality of electrical systems may involve processing the state signals to generate operational state data, the operational state data representing one or more control characteristics of a said electrical system.

Optionally, the flight phase status comprises one of a plurality of potential flight phases including a first flight phase and a second, different, flight phase, and the control characteristic for a said electrical system during the first flight phase is different to the control characteristic for the said electrical system during the second flight phase.

The aircraft control module may be configured to control electrical power distribution in the aircraft in a plurality of different flight phases, such as during take-off and landing, cruising, taxiing, and others. By identifying when control characteristics for a given electrical system vary in two different flight phases, the aircraft control module may control the electrical power supplied to that given electrical system more flexibly and/or efficiently across the plurality of flight phases.

Optionally, the control characteristic comprises power consumption.

Obtaining power consumption requirements for electrical systems in an aircraft that vary depending on a flight phase of the aircraft enables the aircraft control module to control power distribution in the aircraft flexibly. This flexibility can lead to increases in efficiency as the electrical power provided to some electrical systems may be reduced during certain flight phases and increased during other flight phases. Obtaining power consumption for an electrical system may comprise obtaining an indication of the power consumption from storage. Alternatively, obtaining power consumption for an electrical system may comprise determining a power consumption based on any one or more of an indication of a flight phase status and the state signals.

The power consumption may represent an expected, or target, power supply to provide the respective electrical system during the associated flight phase status. The control module, when generating output data, will aim to provide each electrical system with the power consumption associated with the respective electrical systems.

Optionally, the first flight phase comprises a landing phase, the second flight phase comprises a cruising phase, and, for at least one of the electrical systems, the power consumption during the landing phase is less than the power consumption during the cruising phase.

The power consumption of a given electrical system in the aircraft may be different during landing phases and cruising phases where the aircraft functions being controlled in each case are different. The power consumption of an electrical system during the landing phase may be less than the power consumption during a cruising phase where this electrical system is expected to perform fewer of its potential functions, or capabilities, during the landing phase.

This enables the aircraft controller to reduce the amount of electrical power provided to such a system during the landing phase, and thereby have greater capacity to provide electrical power to other electrical systems during the landing phase. While it may be possible to increase the electrical power generated in the aircraft during the landing phase to support all electrical systems at their highest power consumption, reducing the electrical power provided to an electrical system during a landing phase may enable the aircraft to generate less electrical power overall and thereby increase efficiency.

Optionally, the at least one electrical system, for which the power consumption during the landing phase is less than the power consumption during the cruising phase, comprises a power circuit for a passenger comfort system.

A power circuit for a passenger comfort system is an example of an electrical system in the aircraft for which the power consumption may be lower during a landing phase than during a cruising phase. During landing phases, it is possible passenger comfort systems such as air conditioning, entertainment systems, and lighting, to be operated in a low power mode, for example, with certain functions limited or turned off. This in turn may enable more electrical power to be provided to other electrical systems which have higher power consumption during the landing phase, such as the brake control systems, while ameliorating, or preventing, an increase in total electrical power generated in the aircraft.

Optionally, the first flight phase comprises a landing phase, the second flight phase comprises a cruising phase, and, for at least one of the electrical systems, the power consumption during the landing phase is more than the power consumption during the cruising phase.

In contrast to the example of passenger comfort systems, other electrical systems may have higher power consumption during a landing phase than a cruising phase. Similar increases in efficiency can be obtained by reducing the electrical power provided to these systems during other flight phases, such as cruising. In some cases, the power consumption for a certain electrical system may be same during the flight phase and landing phase, but may be higher, or lower, during other flight phases such as taxiing, or planning.

Optionally, the at least one electrical system, for which the power consumption during the landing phase is more than the power consumption during the cruising phase, comprises a power circuit for a braking control system.

Power circuits for braking control systems are example electrical systems in an aircraft which haven higher power consumption needs during landing phases than during cruising phases. As such, the power supplied to the brakes may be increased during landing phases and reduced during cruising phases. The reduction of power supplied during cruising phases may enable other electrical systems, such as passenger comfort systems, to be powered while mitigating an increase in the total power that may need to be generated by the aircraft. Braking control systems may be part of combined braking and steering control systems. Braking and steering control systems are configured to control both steering functions and the operation of the brakes.

Optionally, the control characteristic comprises a power supply priority.

The power supply priority may be indicative of the importance of powering a particular electrical circuit during a respective flight phase on which the power supply priority depends. The power supply priority during a given flight phase may vary amongst the plurality of electrical power systems. The power supply priority may also vary for a given electrical system across the different potential flight phases. By identifying and considering the power supply priority, the aircraft control module may be capable of controlling electrical power distribution more flexibly and more reliably. Using the power supply priority in this way enables the aircraft control system, during any given flight phase, to ensure high priority electrical systems are sufficiently powered. Typically, certain electrical systems in aircraft are treated as high priority at all times. It has been found that broad categorisation of priority for certain electrical systems can be inaccurate and also inefficient. Certain electrical systems, typically treated as high priority at all times, have been found to have highly variant actual priorities of power supply across different fight phases.

Optionally, the first flight phase comprises a landing phase, the second flight phase comprises a cruising phase, and, for at least one of the electrical systems, the power supply priority during the landing phase is lower than the power supply priority during the cruising phase.

As an example, the power supply priority for some electrical systems may be lower during a landing phase than a power supply priority during the cruising phase. For example, certain electrical systems may be associated with functions that are not engaged during landing but are engaged during other flight phases such as cruising. In this case the priority of power supply to these systems may be lower during, landing phases. Even electrical systems which are considered of the highest power supply priority during certain phases, such as cruising, may have lower, or in some cases the lowest, power supply priority during other phases such as landing.

Optionally, the at least one electrical system, for which the power supply priority during the landing phase is lower than the power supply priority during the cruising phase, comprises a power circuit for a passenger comfort system.

Power circuits for passenger comfort systems, such as air conditioning, in-flight entertainment, and others, are examples of electrical systems for which the power supply priority may be lower during a landing phase than during the cruising phase.

Optionally, the first flight phase comprises a landing phase, the second flight phase comprises a cruising phase, and, for at least one of the electrical systems, the power supply priority during the landing phase is higher than the power supply priority during the cruising phase.

For other electrical systems, the power supply priority may be higher during the landing phase than during the cruising phase. These examples are not intended to be limiting examples of electrical systems and their differing power supply priorities during different flight phases of an aircraft. It is noted that some electrical systems may have the same power supply priority during the landing phase and the cruising phase.

Optionally, the at least one electrical system, for which the power supply priority during the landing phase is higher than the power supply priority during the cruising phase, comprises a power circuit for a braking control system.

Power circuits for braking control systems are an example of electrical systems which may have a higher power supply priority during a landing phase than during a cruising phase. While the aircraft is cruising, it may be acceptable for power to the braking control system to be temporarily reduced below normal operating levels used during braking. In some specific cases it may even be acceptable to temporarily power off parts of the braking control system.

Optionally, the control characteristic of a said electrical system of the plurality of electrical systems is dependent on a condition of the said electrical system and the state signals indicate the condition of the said electrical system. For example, the state signals may indicate whether any one or more components in a given electrical system are behaving as expected, or are in an altered operational state. An electrical system may be operating in altered operational state when the electrical system does not behave as expected in response to a control input, or where the electrical system does not provide one or more expected functions.

State signals representing the condition of electrical systems may influence the control characteristics, such as power consumption and/or power supply priority. For example, two electrical systems, a primary system and a redundant system, may be configured to provide power for performing a single function in the aircraft. In normal operation, the power supply priority for both of these systems may be same during each flight phase. However, if the state signals indicate that either of these systems may be operating in an altered state, then the power supply priority for the system operating in the altered state may be reduced, and the power supply priority for the system operating in a normal state may be increased. In this way, the aircraft control module may ensure that redundancy operations are treated as high priority to ensure reliable operation of the aircraft, while being capable of reducing power supplied to certain electrical systems without affecting the operation of the aircraft. The power consumption may be handled similarly in the event of a system operating in an altered state. Electrical systems which are operating in altered states, or have developed faults, may still be supplied with some electrical power. For example, a minimum amount of electrical power to maintain core functions, such as monitoring of the condition of those faulty electrical systems, may be supplied to an electrical system that is determined to be faulty based on respective state signals.

The state signals may alternatively, or additionally, indicate that certain electrical systems are operating in a specific mode for which the control characteristics are different than in other potential operating modes.

Optionally, at least one electrical system of the plurality of electrical systems comprises an integrated power source, and the control characteristic of the at least one electrical system is dependent on a state of the integrated power source.

In some cases, electrical systems in the aircraft may include their own integrated power source. The inclusion of integrated power sources, such as generators or batteries, may be referred to as micro-hybridization. Where electrical systems in the aircraft include their own integrated power sources, the control characteristics may vary, or be modified, to account for this. For example, where an electrical system includes an integrated power source, the power provided to this electrical system by one or more power supplies in the aircraft may be reduced or stopped temporarily without effecting the function of that electrical system as that electrical system may be partially, or wholly, powered by a respective integrated power source. Where certain electrical systems have increased power consumption requirements for short periods, power may be diverted to these electrical systems temporarily without interrupting the function of other electrical systems that include integrated power sources which are capable of being, at least partially, powered by their integrated power sources. Providing integrated power sources in electrical systems enables those systems to be resilient to fluctuations in power provided by external power sources in the aircraft, and to enable the electrical systems comprising these integrated power sources to utilise a consistent power supply level. The state of the integrated power source, such as an indication of its condition, its charge, its capacity for providing power, and other relevant characteristics may influence the control characteristics of the electrical system in which it is included.

Optionally, for the at least one electrical system comprising an integrated power source, the control characteristic comprises at least one of: a measure of power supply potential of the integrated power source; and a measure of energy capacity of the integrated power source.

The control characteristics for electrical systems including integrated power sources may additionally, or alternatively, include characteristics of the integrated power source. Including specific indications of the characteristics of the integrated power source may enable the aircraft control module to utilise the capabilities of the integrated power source more efficiently and may even use the integrated power source to provide power to other electrical systems in the aircraft rather than just supporting the electrical system in which the integrated power source is included.

Optionally, controlling electrical power distribution comprises reducing the electrical power supplied to the at least one electrical system comprising an integrated power source when the measure of power supply potential of the integrated power source is indicative of a capability of the integrated power source to satisfy a power consumption of the associated electrical system.

When the integrated power source, such as a battery, has sufficient charge to power the electrical system in which it is integrated, the power supplied to this electrical system may be reduced. In this way, the control module may be capable to balancing the use of electrical power generated by the power source and the electrical power available in the integrated power source of the electrical system.

Optionally, controlling electrical power distribution comprises at least one of: reducing electrical power supplied to at least one electrical system of the plurality of electrical systems; increasing electrical power supplied to at least one electrical system of the plurality of electrical systems; reducing electrical power supplied by the at least one power source; and increasing electrical power supplied by the at least one power source.

These operations provide mechanisms for the aircraft control module to reconfigure the distribution of electrical power in the aircraft. In practice, these functions may be implemented by the aircraft control module sending signals to low level components such as switches, MOSFETs, microcontrollers, and other electrical componentry that may be used to connect, disconnect, or vary power supplied to certain electrical systems.

Optionally, the aircraft control system comprises a machine learning classifier, and wherein generating output control data comprises processing, using the machine learning classifier, the control characteristic of each of the plurality of electrical systems, the control characteristic of the power source, and the state signals.

Machine learning classifiers, are algorithms designed to categorize or classify data into predefined classes or labels, making them a critical component of supervised learning. These algorithms may be used to analyse input data and use patterns found in the data to predict the category of new, unseen instances. Classifiers can handle a variety of data types, including numerical, categorical, and textual data. Machine learning classifiers, such as neural networks, make highly efficient control systems that are capable of handling multi-dimensional input arrays to determine output control values. Machine learning classifier, and in particular neural networks, provide resilient control systems that, based on training data, are able to learn and implement certain control behaviours or policies. These control policies enable the neural networks to generate suitable outputs even when presented with input data that is outside the compendium of test scenarios on which the neural network has been trained.

Optionally, the control module is configured to: store the output control data; after controlling electrical power distribution in the aircraft using the output control data, obtain further state signals from the plurality of electrical systems; process the further state signals to determine a set of performance indicators; store the set of performance indicators in association with the output control data.

By storing the output control data and performance indicators it is possible to gather large bodies of validation data or test data. This data may be used to refine approaches, reconfigure the electrical systems in the aircraft, and/or may be used as training data for one or more further neural networks, for example future versions, which are to be included in other aircraft control systems.

Optionally, the control module is configured to tune the machine learning classifier using the stored output control data and the associated set of performance indicators.

While the machine learning classifier included in the aircraft control system may be a fully trained and operationally verified machine learning classifier, it may be further tuned and/or refined based on the collected real-world data generated during its operation in the aircraft. In this way, the behaviour of the machine learning classifier may be further improved and/or verified. Additionally, where the characteristics of the aircraft and/or electrical power systems change over time, the machine learning classifier may be adapted to these changes.

Optionally, the plurality of electrical systems includes any one or more of: a power circuit for an in-flight entertainment system; a power circuit for an air conditioning system; a power circuit for a food preparation system; a power circuit for a cabin pressurization system; a power circuit for a flight control system; a power circuit for a navigation system; a power circuit for a braking control system; a power circuit for a landing gear extension and retraction system; a power circuit for a landing gear health monitoring system; a power circuit for a fuel monitoring system; and a power circuit for an engine control system.

As mentioned above, the passenger comfort system and braking control system are provided as illustrative examples of the varying power consumption and power supply priority for different types of electrical systems in an aircraft. Further examples, such as those described above are indicative of further examples of electrical systems to which the present disclosure may be applied. The aircraft control system may control a subset, or all, of the above listed electrical systems according to the processes set out above.

Optionally, the flight phase status of the aircraft comprises any one or more of: a planning phase; a take-off phase; a climbing phase; a cruise phase; a descent phase; an approach phase; a braking phase; and a taxing phase.

The control module may implement the flight phase variability of control characteristics in various potential flight phases as set out above. The control module may be specifically configured to operate in any one or more of these potential flight phases. It is to be appreciated that the control characteristics for any specific electrical system may be the same in certain flight phases, and different in others.

According to a second aspect of the present disclosure, there is provided an aircraft control system configured to control electrical power distribution for a plurality of electrical systems in an aircraft, the aircraft control system comprising a control module configured to: obtain first data indicative of a state of the plurality of electrical systems and a power source; obtain second data indicative of a control characteristic of each of the plurality of electrical systems, wherein the control characteristic of a said electrical system is dependent on a flight phase status of the aircraft; obtain third data indicative a control characteristic of the power source; generate, based on the first through third data, output control data; and control electrical power distribution in the aircraft based on the output control data.

According to a third aspect of the present disclosure, there is provided an aircraft comprising an aircraft control system according to either of the first or second aspects.

According to a fourth aspect of the present disclosure, there is provided a method of controlling power distribution in an aircraft comprising a plurality of electrical systems, the method comprising: obtaining state signals from the plurality of electrical systems and a power source; obtaining a control characteristic of each of the plurality of electrical systems, wherein the control characteristic of a said electrical system is dependent on a flight phase status of the aircraft; obtaining a control characteristic of the power source; generating output control data based on the control characteristics of each of the plurality of electrical systems, the control characteristic of the power source, and the state signals; and controlling electrical power distribution in the aircraft based on the output control data.

Optionally, generating the output control data comprises processing, using a machine learning classifier, the control characteristic of each of the plurality of electrical systems, the control characteristic of the power source, and the state signals.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing an aircraft control system according to examples;

FIG. 2 is a schematic diagram showing the function of an aircraft control system according to examples;

FIG. 3 is a flow diagram showing a method of controlling power distribution in an aircraft according to examples;

FIG. 4 is a schematic diagram showing the function of a control module in a first flight phase and a second, different, flight phase according to examples;

FIG. 5 is a schematic diagram showing examples in which a control module uses a machine learning classifier to obtain control characteristics;

FIG. 6 is a schematic diagram showing examples in which a control module uses a machine learning classifier to generate output control data using control characteristics and/or state signals;

FIG. 7 is a schematic diagram showing examples in which the control module uses a machine learning classifier to generate output control data using state signals and an indication of flight phase status; and

FIG. 8 is a schematic diagram showing a training process for a machine learning classifier according to examples;

FIG. 9 is schematic diagram showing an electrical network of an aircraft according to examples; and

FIG. 10 is a schematic diagram of an aircraft comprising an aircraft control system according to examples.

### DETAILED DESCRIPTION

An electrical network in an aircraft generally includes a plurality of electrical systems, including their respective electrical components, and their interconnections that generate, distribute, and utilize electrical power throughout the aircraft. Electrical networks are core to the functioning of modern aircraft's operation, supporting both flight operations and passenger comfort systems. This includes navigation systems, communication systems, cabin lighting, fuel systems, flight control systems, and many other components that require electrical power to operate.

Electrical power distribution in an aircraft refers to the systems and/or methods responsible for generating, managing, and distributing electrical power to all the electrical systems and components in the electrical network. Modern aircraft generally employ Electrical Power Management Systems (EPMS) that monitor and control the distribution of electrical power, to pursue optimum performance and reliability.

Due to modern aircraft's increasing capabilities, size, features, and improvements in electronic control systems, electrical networks in modern aircraft are more complex than electrical networks of older aircraft. The complexity of these electrical networks continues to increase and a shift towards the use of electrical power for certain aircraft functions may act to increase the already complex electrical networks of aircraft.

As the features and functions that modern aircraft are designed to provide increases, the power requirements for powering these aircraft are commensurately increasing. Aircraft are typically powered by internal combustion and/or jet engines, which are used to drive generators configured to produce electrical power. The amount of electrical power available in the aircraft to power electrical systems may be limited by the engine load, limited electrical power generation systems, and electrical storage equipment such as batteries.

It is desirable to reduce the total amount of electrical power used by electrical systems in aircraft in order to mitigate an increase in the fuel consumed by aircraft, and to enable more reliable and consistent powering of electrical systems. Reducing the electrical power consumed in aircraft may also make the inclusion of alternative electrical power sources, such as solar panels or batteries charged using renewable energy sources on the ground, feasible sources of electrical power during operation of the aircraft, thereby further reducing the fuel consumption.

Certain examples described herein provide an aircraft control system, and method, configured to control electrical power distribution in an aircraft with greater flexibility, and more efficiently, than other known electrical power distribution systems in aircraft. The aircraft control system obtains control characteristics of a plurality of electrical systems in the aircraft. The control characteristics of the plurality of electrical systems are dependent on a flight phase status of the aircraft. These control characteristics are used, in combination with control characteristics of a power source and state signals from the electrical systems, to control electrical power distribution in the aircraft. By using control characteristics that vary depending on a flight phase status of the aircraft it is possible to flexibly reconfigure the electrical network in response to changing power consumption requirements for the electrical systems.

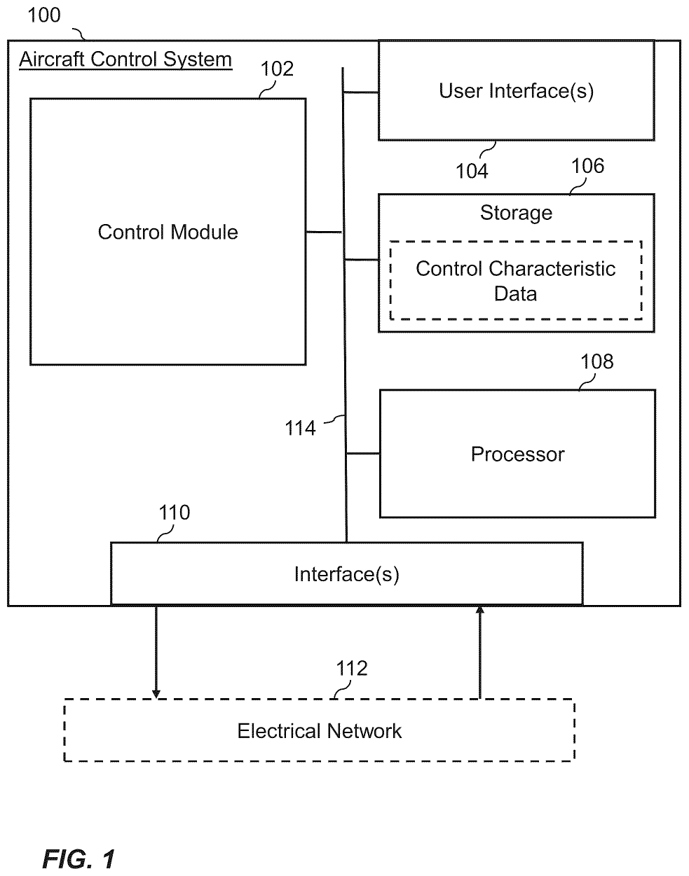

FIG. 1 shows an example of an aircraft control system 100 comprising a control module 102 that is configured to perform a method of controlling power distribution for a plurality of electrical systems in an aircraft. The control module 102 is implemented as a combination of hardware and or software in the aircraft control system 100. The control module 102 includes a processor and a set of computer-executable instructions which, when executed by the processor, cause the control module to control power distribution in an aircraft in which the aircraft control system 100 is provided.

As shown in FIG. 1, the aircraft control system 100 comprises one or more user interfaces 104, a storage 106, a processor 108, and one or more interfaces 110 for communicating with and/or controlling an electrical network 112 comprising a plurality of electrical systems of an aircraft. The components in the aircraft control system 100 are connected over a communications interface 114, such as a bus. The aircraft control module 100 is shown as a single contained device, however, it is to be appreciated that in other examples, the aircraft control system 100 may be implemented using a plurality of physically separate but communicatively coupled computing devices or units, that are distributed in an aircraft.

The user interface(s) 104 include any suitable interface to enable a human operator to provide inputs and/or receive outputs from the aircraft control system 100. Examples, of user interfaces 104 include buttons, displays, touchscreens, controllers, or interfaces to connect to any of these types of components.

The storage 106 includes a suitable combination of volatile and/or non-volatile memory. Volatile memory may be used to mount data that is to be readily accessed for performing one or more functions and non-volatile memory, such as Read-Only Memory (ROM), is used for longer term persistent storage of data. The storage 106 stores instructions for controlling one or more functions in the aircraft, wherein the instructions may be executed by the processor 108. The storage 106 may additionally, or alternatively, be used to store other types of data including scenario data, flight data, weather data, performance data, and so forth.

The processor 108 includes a suitable combination of processing circuitry including: general purpose central processing units (CPUs), graphic processing units (GPUs), application specific integrated circuits (ASICs), fixed programmable gate arrays (FPGAs), or any other suitable processing circuitry. In aircraft control systems 100 a variety of processing circuitry types may be employed to support different functions. For example, where low-latency, and often lower complexity, processing is required FPGAs or ASICs may be more suitable than for tasks requiring more complex processing, wherein CPUs or GPUs may be more suitable.

The interface(s) 110 for communicating with and/or controlling the electrical network 112 may include any suitable combination of control interfaces. The interface(s) 110 are configured to process control data, generated by the control module 102, and to convert the control data into a set of instructions to be sent to various electrical components in the electrical network 112 to implement any functions defined in the control data. The interface(s) 110 may be capable of performing digital to analogue conversion of electrical signals, to produce signals suitable for actuating or controlling components in the electrical network 112.

The processor 108, storage 106, user interface 104, and further interfaces 110 support the functions of the control module 102. The control module 102 may store or access data from the storage 106, instruct the processor 108 to perform one or more operations, receive instructions or communicate with users using the user interface(s) 104, and communicate with the electrical network 112 using the interface(s) 110. The additional components 104 to 110 in the aircraft control system 100 may be configured to perform one or more further functions for aircraft control.

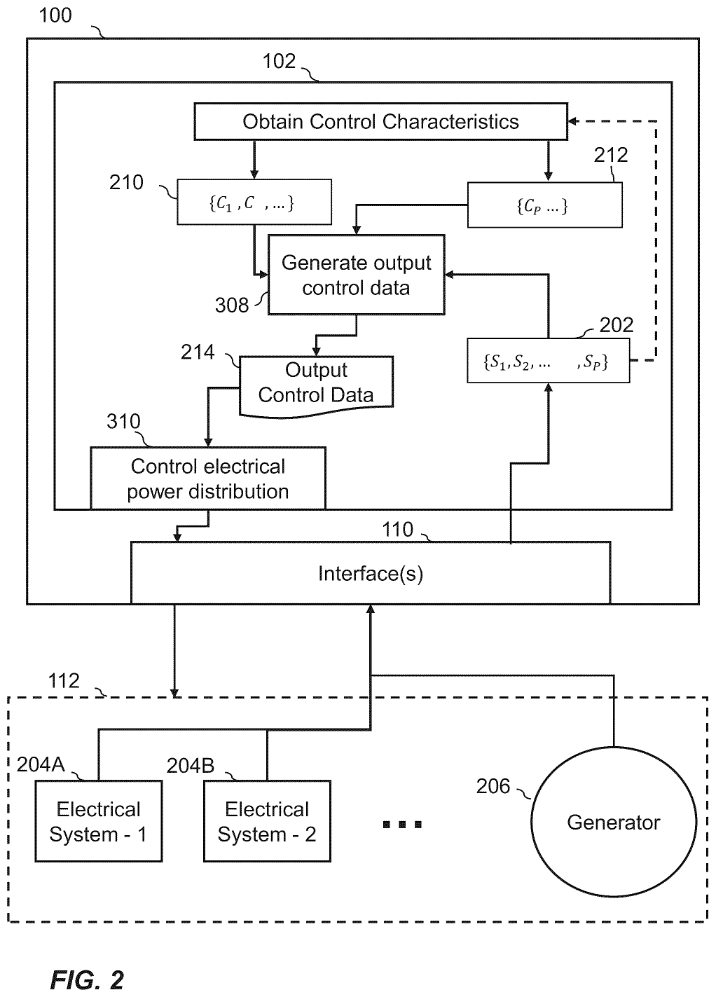

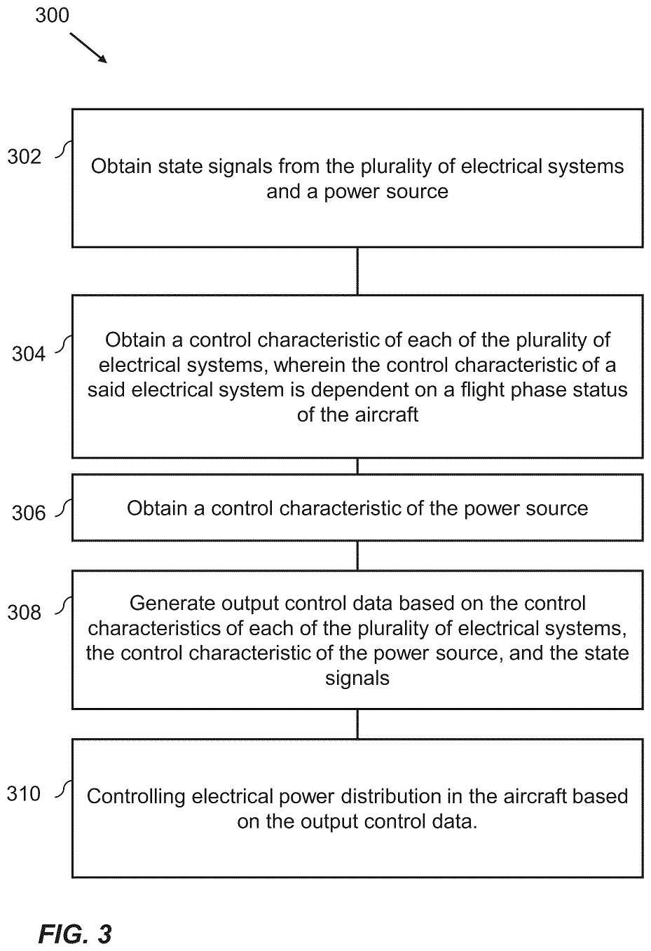

A method 300 of controlling electrical power distribution in the aircraft, that is implemented by the control module 102, will now be described with reference to FIGS. 2 and 3.

The control module 102 obtains 302 state signals 202 from a plurality of electrical systems 204A and 204B and a power source 206. The state signals 202 indicate one or more operating characteristics of the respective electrical systems 204A and 204B and power source 206 from which they are provided.

The control module 102 obtains 304 control characteristics 210 of each of the plurality of electrical systems 204A and 204B. The control characteristics 210 are dependent on a flight phase status of the aircraft, such that the specific control characteristic C₁ of a first electrical system 204A varies depending on whether the aircraft is in a landing phase, or a cruising phase.

In the example shown in FIG. 2, the control characteristics 210 of the electrical systems 204A and 204B include a first control characteristic C₁ associated with a first electrical system 204A and a second control characteristic C₂ associated with a second electrical system 204B. Although not shown, further control characteristics may be obtained, for example, relating to third or more electrical systems, also not shown.

The control module 102 obtains 306 a control characteristic 212 of the power source 206, representing an operating state, or condition, of the power source 206. The control module 102 generates 308 output control data 214, based on the control characteristics 210 of each of the plurality of electrical systems 204A and 204B, the control characteristic 212 of the power source 206, and the state signals 202. The output control data 214 is then used to control 310 electrical power distribution in an aircraft.

Controlling 310 power distribution in the aircraft comprises reconfiguring the electrical network 112 connecting the plurality of electrical systems 204A and 204B and the power source 206 to provide electrical power to the electrical systems 204A and 204B. By considering flight phase-variant control characteristics 210 for the plurality of electrical systems 204A and 204B it becomes possible to manage electrical power distribution more flexibly in the aircraft. For example, the control module 102 may reduce the power provided to a given electrical system 204A when it has been found that the expected power consumption for that system 204A is reduced during a given flight phase and/or where the priority of providing power to the given electrical system 204A is determined to be lower during a given flight phase.

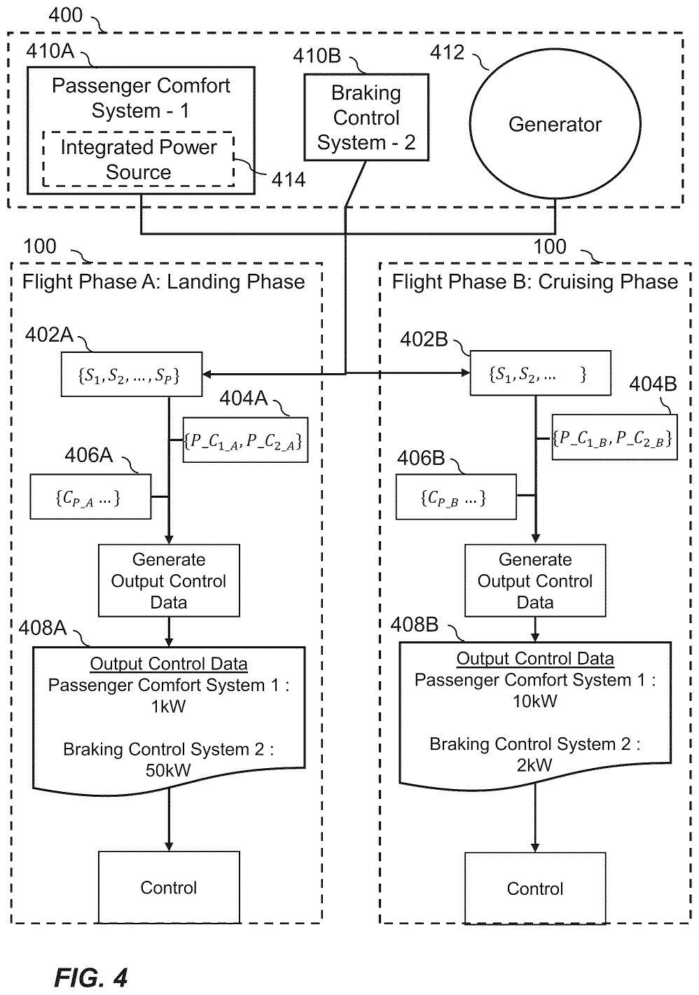

FIG. 4 shows an example of the function of the aircraft control system 100 in a first, landing, flight phase and the function of the aircraft control system 100 in a second, cruising, flight phase. Elements 402A to 408A which are applicable to both the landing phase and the cruising phase are referenced using the same numeral but with a respective suffix A or B, referring to either the landing phase, A, or the cruising phase, B. In this example, the first electrical system 204A comprises a power circuit for a passenger comfort system 410A, the second electrical system 204B comprises a power circuit for a braking control system 410B, and the power source 206 is a generator 412.

Referring first to the landing phase, A, the control characteristics 404A comprise a power consumption P_C_{1_A} for the power circuit for the passenger comfort system 410A and a power consumption P_C_{2_4} for the power circuit for the braking control system 410B. The power consumption P_C_{1_4} and P_C_{2_4} of each of the passenger comfort system 410A and the braking control system 410B included in the control characteristics is indicative of an expected power consumption for powering one or more functions that the respective system 410A or 410B is expected to perform during the respective flight phase.

Output control data 408A is generated using the state signals 402A, the power consumption {PC₁_{₄}, P_C_{2_A}} for each of the power circuit for the passenger comfort system 410A and the power circuit for the braking control system 410B, and the control characteristic 406A of the generator 412. It will be appreciated that the maximum power consumption necessary to power the passenger comfort system 410A and the braking control system 410B in any given flight phase may be different. The difference between the power consumption of the passenger comfort system 410A and the braking control system 410B may also vary during different flight phases of the aircraft. During the landing phase the braking control system 204B has a power consumption at, or near, its maximum power consumption, whereas the passenger comfort system 410A is expected to consume less than its maximum power consumption, due to one or more components in the passenger comfort system 410A being turned off, or on standby, during the landing phase.

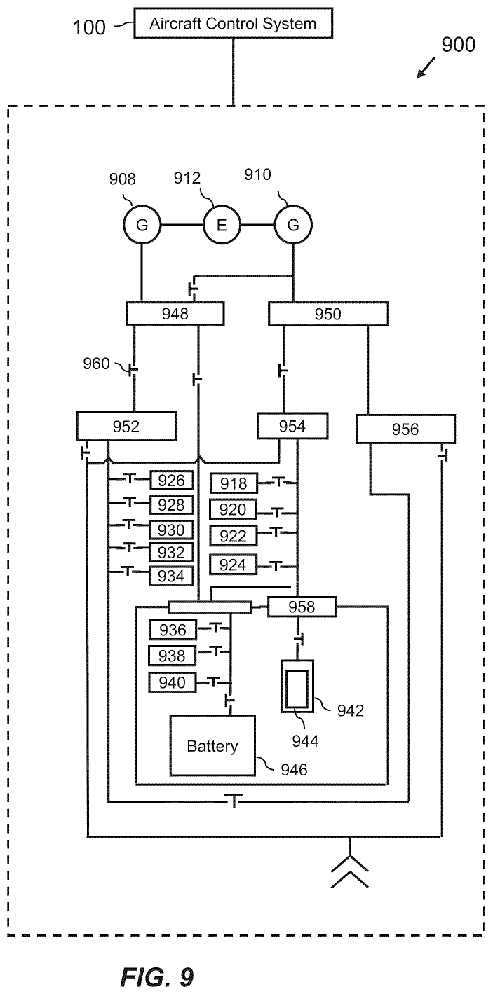

The output control data 408A for controlling electrical power distribution during the landing phase is indicative of an amount of power to be provided to each of the power circuits for the passenger comfort system 410A and the power circuit for the braking control system 410B. It will be appreciated that, while indicative of an amount of power to provide to different electrical systems, the output control data 408A may actually comprise a set of instructions for controlling the electrical network 400 to deliver power to each of the passenger comfort systems 410A and the braking control system 410B. Controlling 310 electrical power distribution involves any one or more of reducing or increasing electrical power supplied to the passenger comfort system 410A and the braking control system, and/or reducing or increasing the power supplied by the generator 412. A more detailed example of an electrical network 400, and how electrical power distribution can be performed, will be described later with respect to FIG. 9.

A similar process is performed during the cruising phase, B, however, in this case the power consumption {P_C_{1_B}, P_C_{2_B}} of each of the passenger comfort system 410A and the braking control system 410B is different. For example, the power consumption P_C_{1_B} of the power circuit for the passenger comfort system 410A is greater during the cruising phase than the power consumption P_C_{1_A} during the landing phase. During the cruising phase, the passenger comfort system 410A may be expected to perform more of the functions it is capable of, such as playing media on headrest units, which would otherwise be turned off during landing.

In contrast, the power consumption P_C_{2_B} of the power circuit for the braking control system 410B is lower during the cruising phase. During the cruising phase the braking control system 410B may operate in a low power mode or be switched off. The lower power mode may involve the braking control system 410B performing one or more essential operations, such as communicating its state to the aircraft control system 100, but with a number of higher power functions, such as braking, being unused.

While the control characteristics 404A and 404B of the passenger comfort system 410A and the braking control system 410B specify a power consumption for each these systems 410A and 410B, the power supplied to the systems 410A and 410B according to the output control data 408A and 408B may not be the same as that specified in the control characteristics 404A and 404B.

The amount of power available to the control module 102 to power the passenger comfort system 410A and the braking control system 410B in the aircraft, is dependent on the amount of power generated by the generator 412 and may be limited depending on a flight phase in which the aircraft is operating. For example, during certain flight phases, the generator 412 may produce less power than during other flight phases. The amount of power that the generator 412 is capable of generating in any given flight phase is represented by the respective control characteristics 406A and 406B of generator 412.

By obtaining control characteristics 404A and 404B for the passenger comfort system 410A and the braking control system 410B that vary depending on the flight phase status of the aircraft, the control module 102 is capable of making more sophisticated decisions with respect to electrical power distribution, and thereby increase the efficiency with which electrical power is distributed in the aircraft.

The power circuit for the passenger comfort system 410A comprises an integrated power source 414. The inclusion of integrated power sources 414 such as, batteries or generators, into electrical systems 204A, in aircraft may be referred to as micro hybridisation. By powering some functions, which are currently powered by the main engines, with electric alternatives, micro-hybridisation can lead to lower fuel consumption and reduced emissions. This is particularly relevant for non-propulsive functions like: air conditioning and cabin pressurization; communications and flight controls; and landing gear.

In this case the control characteristic specifically the power consumption P_C_{1_4} or P_C_{1_B}, of the passenger comfort system 410A is dependent on a state, such as a condition, of the integrated power source 414. The state of the integrated power source 414 may, for instance, affect the power consumption P_C_{1_A} or P_C_{1_B} of the passenger comfort system 410A. The power consumption P_C_{1_A} or P_C_{1_B} may be reduced in this case because the charge stored in, or generated by, the integrated power source 414 may be used to power the circuit for the passenger comfort system 410A. Alternatively, the power consumption P_C_{1_A} or P_C_{1_B} may be increased because, where the integrated power source 414 comprises a battery, the power consumption of the passenger comfort system 410A may account for power to be used to charge the battery.

In the example described above, the power consumption P_C_{1_A} or P_C_{1_B} of the passenger comfort system 410A comprising the integrated power source 414 is dependent on the state of the integrated power source 414. In other examples, the control characteristic 404A of the passenger comfort system 410A may comprise a measure of power supply potential of the integrated power source 414 and/or a measure of energy capacity of the integrated power source 414.

The measure of power supply potential represents the potential for the integrated power source 414 to provide electrical power in the electrical network 400, which may be expressed as in terms of Watts (W), Watt Hours (e.g. kWh, or Wh), Amp Hours (Ah), Coulombs (C), or as a suitable combination of other electrical characteristics such as voltage, current, and/or duration.

The energy capacity of the integrated power source 414 represents a total capacity, or a charge deficit, of a battery included in the integrated power source 414. The control module 102 may, in some circumstances, provide the passenger comfort system 410A with more electrical power to charge the battery of the integrated power source 414. Charging a battery of the integrated power source 414 during flight phases in which electrical power is available may subsequently reduce the power consumption of the passenger comfort system 410A during flight phases in which powering other electrical systems is a greater priority. For example, during climbing phases, there may be an abundance of electrical power generated by generators connected to the engines. The control module 102 may use the abundance of electrical power generated during the climbing phase to charge one or more integrated power supplies of electrical systems, to balance the energy use during flight phases in which the generators attached to the engines are generating less electrical power.

When reconfiguring the distribution of electrical power in the aircraft, the aircraft control system 100 may provide electrical power to charge an integrated power supply of a given electrical system in advance of a flight phase where that given electrical system is to be used. For example, the aircraft control system 100 may anticipate that during a future braking phase the electrical power consumption of the braking control system 410B may be greater than during a descent phase. Where the braking control system 410B comprises an integrated power source (not shown), the aircraft control system 100 may increase the power provided to the braking control system 410B during the descent phase to charge the integrated power source in the braking control system 410B. To this end, the power consumption characteristics of the braking control system during the descent phase may represent a greater power consumption to account for charging of the braking control system's 410B integrated power supply. In this way, the braking control system 410B can maintain a sufficient amount of electrical power supply during the braking phase while being more resilient to fluctuations in power supplied from the generator 412. Using an integrated power supply in the braking control system 410B also enables the power supplied to other electrical systems during the braking phase, by the generator 412, to be increased without sacrificing braking performance.

The examples described with respect to FIG. 4 illustrate that the power consumption P_C_{1_A} or P_C_{2_A}, for any given system 410A and 410B may vary depending on the flight phase status of the aircraft. As shown, the relationship between flight phase and power consumption differs between the electrical systems 204A and 204B in the aircraft. While some electrical systems 204A have a higher power consumption, or expected power consumption, during a first flight phase, such as cruising, than during a second flight phase, such as landing, for other electrical systems 204B this relationship is reversed. The specific relationship between flight phase and power consumption may be specific to the type of electrical system, and some types of electrical system in the aircraft may have the same, or similar, relationship between power consumption and flight phase.

In some cases, the power consumption for a given electrical system may be the same during the landing phase and the cruising phase. Other flight phases are also contemplated including, but not limited to, a planning phase, wherein pilots are performing pre-flight planning operations; a take-off phase; a climbing phase, including the duration of flight following take-off and prior to achieving cruising altitude; a descent phase, involving the initial descent prior to the approach phase; an approach phase, in which the aircraft approaches a landing area or runway; a braking phase; and a taxiing phase, including the control of the aircraft on the tarmac before take-off and after landing.

Alternatively, or additionally, to the specific example described above with respect to FIG. 4, the control characteristics 210 for any one or more of the electrical systems 204A and 204B may comprise a power supply priority. The power supply priority is indicative of the priority of providing the respective electrical system 204A and 204B with sufficient power during a respective flight phase, to power certain functions of the electrical system 204A and 204B.

The relationship between power supply priority for any given electrical system may vary depending on a flight phase status of the aircraft. Using the example in which the first electrical system comprises the power circuit for a passenger comfort system 410A and the second electrical system comprises the power circuit for a braking control system 410B, during the landing phase, A, the power supply priority of the power circuit for the braking control system 410B is higher than during the cruising phase, B. During the landing phase, the braking control system 410B may be performing certain pre-braking checks and or operations in anticipation of performing braking during a braking phase.

Additionally, the relationship between power supply priority and flight phase status may differ between certain electrical systems, wherein some electrical systems 204A and 204B are considered to be higher priority during certain flight phases than other electrical systems 204B and 204A. Braking control systems 410B, for example, are considered higher priority during the landing phase, A, than passenger comfort systems 410A, such as entertainment systems.

Where the control characteristics 210 of the electrical systems 204A and 204B comprise a power consumption and a power supply priority, the control module 102 may be capable of sophisticated control of electrical power distribution in the aircraft. The control module 102 in this case may be capable of making complex trade-off decisions, identifying and shedding certain electrical loads that are low priority in order to achieve a desired level of power supply to higher priority loads. If power capacity provided by the power source 206 is lower than the total amount of power required to power all of the electrical systems 204A and 204B in the aircraft during a given flight phase, the control module 102 may shed loads that are lower priority.

Generally, the priority of providing power to certain electrical systems 204A and 204B is assumed to depend on the type of electrical system. Engineers and designers may deem certain electrical systems to be higher priority than others, and thereby configure a list, or hierarchy, of electrical systems to enable a control module 102 to shed the lowest priority electrical systems first. However, it has been found that, by enabling the control module 102 to consider varying priorities of power supply based on flight phase, more flexible and reliable power supply can be achieved in the aircraft.

Returning to the example of FIG. 4, the control characteristics 404A of one or more of the passenger comfort system 410A and the braking control system are dependent on the state signals 402A associated with the respective system 410A and 410B. As described briefly above, the state signals 402A, are indicative of an operating characteristic, such as a condition, of the respective system 410A and 410B to which they are associated. By obtaining a control characteristic 404A that is sensitive to both the flight phase status and the operating characteristics of the electrical system 410A and 410B, the control module 102 is capable of making more sophisticated decisions with respect to power distribution in the aircraft. For example, where there are two redundant electrical systems for powering the braking control system, and where one of these redundant electrical systems develops a fault or is operating in an altered state, the control module 102 may identify that faulty electrical system can be disconnected, or unpowered. This may be indicated by assigning the faulty system with a lower expected power consumption, or a lower power supply priority, than the other, fully functional, braking control system. This will reduce the total load and allow more electrical power to be diverted to the operational electrical system for powering the braking control system.

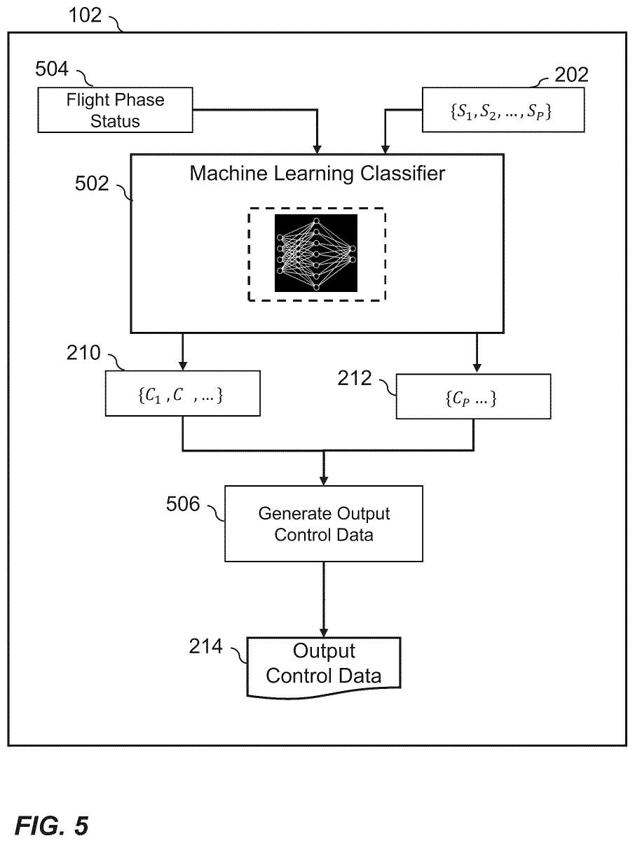

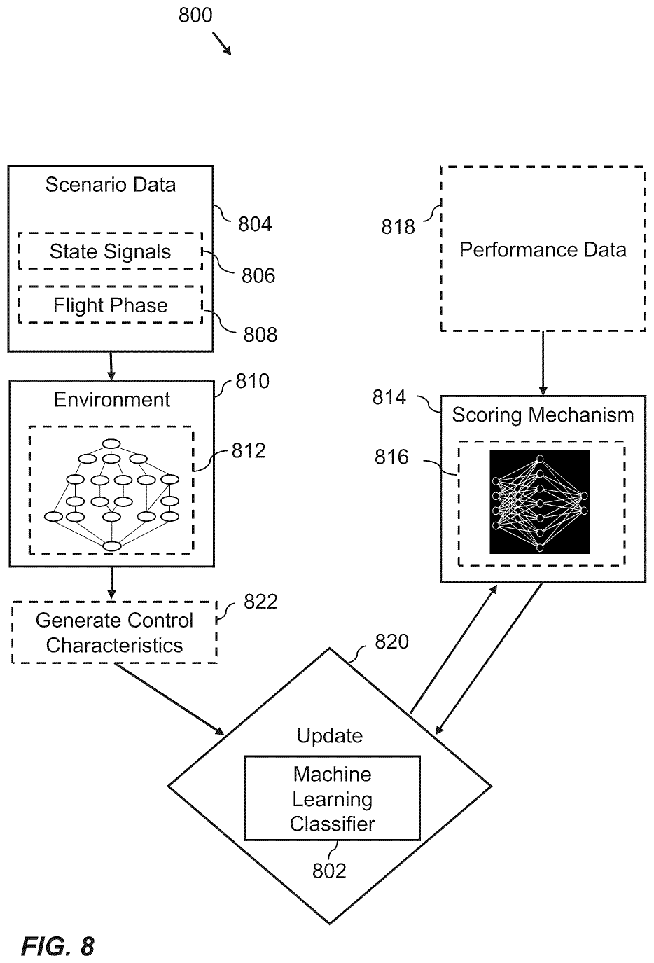

One or more functions of the control module 102 are implemented using a machine learning classifier, such as a neural network. A machine learning classifier may be used to obtain the control characteristics 210 and/or 212, to generate the output control data 214, or to both obtain the control characteristics 210 and/or 212 and generate the output control data 214. FIGS. 5 to 7 show various examples of the implementation of a machine learning classifier in the control module 102. Processes for training the machine learning classifiers will be described with respect to FIG. 8.

Machine learning classifiers, such as neural networks have several attributes that make them suitable for inclusion in a control module 102 for these functions. Machine learning classifiers provide accurate non-linear function approximation making them well suited for approximating non-linear relationships in real-world systems. Machine learning classifiers are capable of adapting to changes in system dynamics and environments, making them suited for used in a wide variety of aircraft in which the specific systems may vary. Machine learning classifiers are fault tolerant due their distributed architecture, and are capable of generalizing control behaviours making them suitable for applications in new, or unseen, situations which are not explicitly contemplated by engineers or developers.

FIG. 5 shows an example in which the control module 102 comprises a machine learning classifier 502 which is configured to process the state signals 202 and an indication of a flight phase status 504 to determine the control characteristics 210 of the plurality of electrical systems 204A and 204B and/or the control characteristics 212 of the power source 206. The machine learning classifier 502 comprises a neural network that is trained to process the indication of the flight phase status 504 and state signals 202 as inputs to determine the control characteristics 210 and 212. Rather than deterministic program code being used to specify what the control characteristics 210 and 212 should be, the machine learning classifier 502 is trained to determine control characteristics 210 and 212 based on data representing a plurality of potential operating scenarios. In this way, the machine learning classifier 502 may be capable of determining control characteristics 210 and 212 that are different to assumed control characteristics specified by engineers and/or designers according to deterministic rules or program code.

Where the machine learning classifier 502 is configured to determine the control characteristics 210 and 212, the control module 102 implements a function 506, or set of instructions, that are configured to generate the output control data 214, based on the control characteristics 210 and 212 determined using the machine learning classifier. The function 506 may be configured or developed by engineers and adapted to process the control characteristics 210 and 212 determined by the machine learning classifier 502. In this case, the function 506 is a deterministic or hard programmed function configured to process the control characteristics 210 and 212 to generate the output control data 214.

By using the machine learning classifier 502 to determine the control characteristics 210 and 212 it becomes possible to provide variable control characteristics 210 and 212 that are dependent at least on the flight phase status 504. Where the control characteristics 210 comprise a power supply priority, the machine learning classifier 502 may be capable of determining lower power supply priorities for electrical systems 204B that, while typically considered high priority, can be downgraded during specific flight phases to mitigate or prevent a reduction of power supplied to other electrical systems, which may be considered more important during that given flight phase.

Additionally, the use of the state signals 202 by the machine learning classifier 502 enables the control characteristics 210 and 212 determined by the machine learning classifier 502 to be sensitive to the state or condition of the electrical systems 204A and 204B. As discussed above, the state signals 202 may indicate when an electrical system 204A or 204B, or a component therein, is operating in an altered state, or has developed a fault. By processing the state signals 202 using the machine learning classifier 502, the machine learning classifier 502 may be capable of identifying these conditions and reducing the power supplied to that electrical system 204A or 204B.

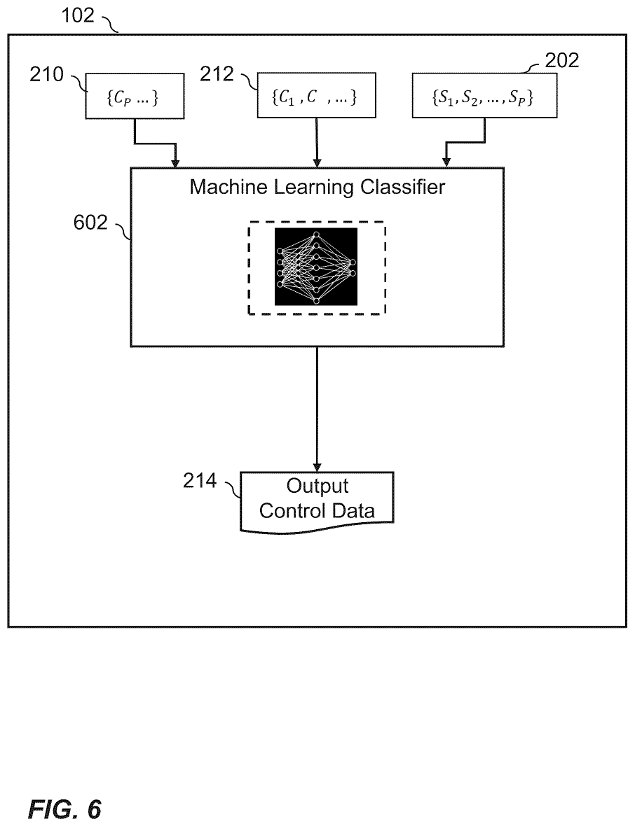

FIG. 6 shows an example in which the control module 102 comprises a machine learning classifier 602 that is configured to process control characteristics 210 and 212 and state signals 202 to generate the output control data 214. This arrangement may be used where the control characteristics 210 and 212 of the electrical systems 204A and 204B and/or the power source 206 are determined based on data, such as lookup tables, in the storage 106. In this example, the control characteristics 210 and 212 supplied to the machine learning classifier 602 are dependent on the flight phase status of the aircraft and no indication of the flight phase status may be provided to the machine learning classifier 602. The machine learning classifier 602 in this example may be similarly trained to generate output control data based on control characteristics 210 and 212 and state signals 202 for a plurality of potential operating scenarios.

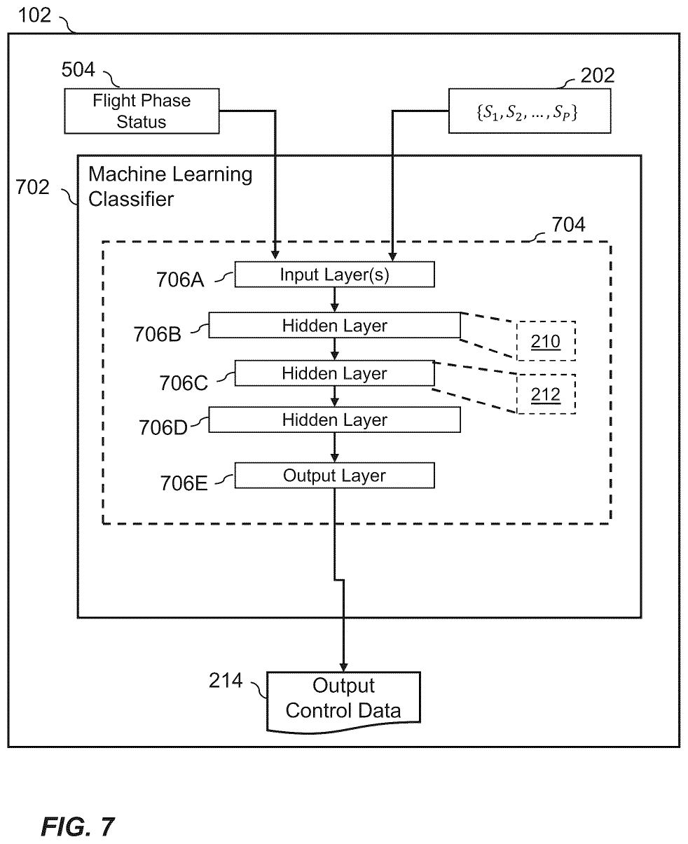

FIG. 7 shows an example in which the control module 102 comprises a machine learning classifier 702 that is configured to process the state signals 202 and the indication of a flight phase status 504 to generate the output control data 214. The machine learning classifier 702 comprises a neural network 704 that includes a plurality of layers 706A to 706E including an input layer 706A, one or more hidden layers 706B to 706D, and an output, or fully connected, layer 706E. In this example, the control characteristics 210 and 212 may not be output as specific values but may instead be inferred in one or more of the hidden layers 706B to 706D of the neural network 704. The neural network 704, through a series of convolutional operations, infers the values of the control characteristics 210 and 212 and uses these inferences to generate the output control data 214.

While a specific architecture of the neural network 706 is shown in FIG. 7 it will be appreciated that any suitable neural network architecture may be used. For example, the neural network 706 may comprise a plurality of sub-networks. This may involve using two or more sub-networks, configured to obtain the control characteristics 210 and 212, and output the control characteristics 210 and 212 to a further sub-network that is configured to generate the output control data 214. The neural network 706, and the neural networks described above with respect to the examples of FIGS. 5 and 6, may include any suitable network architecture including feed forward networks (FFNs), convolutional neural networks (CNNs), transformer networks, recurrent neural networks (RNNs), long short-term memory (LSTM) networks, and so forth.

FIG. 8 shows an example of a process 800 for training a machine learning classifier 802 to perform the functions of the control module 102 described above with respect to the examples shown in FIGS. 5 to 7. Scenario data 804, representing a plurality of operating scenarios for an aircraft, is provided. Each operating scenario for the aircraft is represented according to a set of state signals 806 and an indication of a flight phase status 808 for the scenario. As discussed above, the control module 102 is configured to control electrical power distribution in a number of possible flight phases of the aircraft. To this end, the plurality of operating scenarios includes operating scenarios for a plurality of different flight phases.

For each scenario, an environment 810 representing the plurality of electrical systems 204A and 204B and the power source 206 is updated based on a respective portion of the scenario data 804, to reflect the given scenario. This involves configuring the environment 810 such that it represents the states, functions, and availability of electrical systems 204A and 204B and power source 206 in the aircraft according to the given scenario.

The environment 810 includes a graph model 812, simulating the plurality of electrical systems 204A and 204B and the power source 206 in the aircraft. The graph model 812 comprises a plurality of nodes and connecting edges. Various graph model implementations may be used, in this case, the nodes of the graph model 812 represent control functions or decisions that the control module 102 may take when controlling electrical power distribution in the aircraft. In this case, updating the environment 810 based on the scenario data 804 involves modifying, or restricting the operation of, one or more nodes in the graph model 812, for example, to represent a certain system or function being unavailable based on the scenario data 804. Where the state signals 806 represent the condition of a respective electrical system, the graph model 812 may be modified to reflect this condition. If the state signals 806 indicate that a given electrical system has developed a fault in the respective scenario, the graph model 812 may be updated to indicate that the electrical system is not operational.

A scoring mechanism 814, that is configured to evaluate the performance of the machine learning classifier 802 in each of a plurality of scenarios represented in the scenario data 804 is provided. The scoring mechanism 814 is configured to evaluate the performance of the outputs of machine learning classifier 802 when used to control electrical power distribution in comparison to an expected performance of electrical power distribution for the given scenario. For example, the scoring mechanism 814 may determine how much power is provided to any one or more of the electrical systems 204A and 204 during the scenario, when controlled using outputs from the machine learning classifier 802, and compare this to an expected power to be supplied to each of the electrical systems 204A and 204B during the scenario.

Alternatively, or additionally, the scoring mechanism 814 may evaluate the performance of the aircraft when electrical power distribution is controlled according to the outputs from the machine learning classifier 802. In this case, evaluating the performance of the aircraft overall, rather than the electrical power supplied to each system, may prevent biased assumptions of electrical power distribution from inhibiting the machine learning classifier 802 in learning new and efficient ways of controlling electrical power distribution.

The scoring mechanism 814 can include a deterministic model which is configured to evaluate an output of the machine learning classifier 802 for each scenario. In other examples, the scoring mechanism 814 may implement its own machine learning classifier, such as a neural network 816 that is trained to evaluate the performance of the machine learning classifier 802 either by evaluating the output control data 214 in comparison to expected output control data, or by evaluating a performance of the aircraft when controlled according to the output control data 214.

The neural network 816 is trained, or configured, according to performance data 818. The performance data 818 is representative of a desired or target performance for controlling electrical power distribution in an aircraft in a plurality of scenarios. The performance data 818 may indicate, for each scenario, performance characteristics such as power supplied to each electrical system. Alternatively, or additionally, the performance data 818 may include a set of expected control outputs for each scenario.

The steps involved in training the machine learning classifier 802 are dependent on the specific function for which that machine learning classifier 802 is being trained.

Where the machine learning classifier 802 is being trained to perform the functions of the machine learning classifier 502 described with respect to the example of FIG. 5, the machine learning classifier 802 is used to generate control characteristics 210 and 212 based on the environment 810. The control characteristics 210 and 212 generated by the machine learning classifier 802 are processed using the scoring mechanism 814 and the machine learning classifier 802 is updated 820 according to this scoring mechanism 814. Various functions for updating the machine learning classifier 802 may be used, including, genetic algorithms, or backpropagation in which a gradient loss function is computed and iterated backwards through the machine learning classifier 802, updating parameters or weight values representing the machine learning classifier 802. This process is performed for a plurality of scenarios represented by the scenario data 804 to obtain the trained machine learning classifier 802 suitable for inclusion in the control module 102.

Where the machine learning classifier 802 is being trained to perform the functions of the machine learning classifier 602 described above with respect to the example of FIG. 6, the process 800 involves generating 822 control characteristics 210 and 212 for the given scenario. The machine learning classifier 802 is used to generate output control data based on the control characteristics 210 and 212, and the output control data is evaluated using the scoring mechanism 814. The machine learning classifier 802 is then updated according to the scoring mechanism 814.

Where the machine learning classifier 802 is being trained to perform the functions of the machine learning classifier 702 described above with respect to the example of FIG. 7, the process 800 may exclude the step of generating 822 control characteristics. As described above, the machine learning classifier 802 may infer, implicitly or explicitly, the control characteristics 210 and 212 prior to generating output control data 214 that is to be evaluated according to the scoring mechanism 814.

The machine learning classifier 802 can be further tuned after deployment in the control module 102. To this end, the control module 102 may be configured to store the output control data 214 and obtain further state signals from the plurality of electrical systems 204A and 204B after controlling electrical power distribution in the aircraft. The further state signals are processed to determine a set of performance indicators, representative of how well the control module 102 performs in controlling electrical power distribution. The set of performance indicators are stored in association with the output control data 214, and can be used by the control module 102 to evaluate and/or tune the machine learning classifier 802 after deployment. To tune or update the machine learning classifier 802 after deployment, the control module 102 may implement a scoring mechanism and/or feedback function for updating one or more characteristics of the machine learning classifier 802.

FIG. 9 shows an example of an electrical network 900 of an aircraft, comprising a plurality of electrical systems 918 to 942. It will be appreciated that the electrical network 900 shown in FIG. 9 is simplified to aid understanding.

The electrical network 900 comprises a plurality of power sources in the form of a primary generator 908 and a secondary generator 910 connected to a first engine 912 and used to generate electrical power.

The electrical network 900 comprises a plurality of electrical systems 918 to 942 of the aircraft including, but not limited to: power circuits for in-flight entertainment systems 918, power circuit for an air conditioning system 920; a power circuit for a food preparation system 922; a power circuit for a cabin pressurization system 924; a power circuit for a flight control system 926; a power circuit for a navigation system 928; a power circuit for a braking control system 930; a power circuit for a landing gear extension and retraction system 932; a power circuit for a landing gear health monitoring system 934; a power circuit for a fuel monitoring system 936; and a power circuit for an engine control system 938. Although not shown, it is to be appreciated that the electrical network 900 may comprise a plurality of each type of electrical system 918 to 942. The electrical network 900 comprises one or more batteries 946 as a backup, or additional, power source for powering one or more of the electrical systems 918 to 942 in the aircraft. At least one of the electrical systems 942 comprises an integrated power source 944, such as a battery or back-up generator.

The electrical systems 918 to 942 in the aircraft are connected using various components including buses, electromechanical switches 960, AC transformers 948 to 956, and DC transformers 958. The control module 102 controls electrical power distribution in the electrical network 900 using any one or more of these components 948 to 960, for example, by disconnecting, or reconfiguring, the electrical loads provided to electrical systems 918 to 942 in the aircraft. It will be appreciated that only one electromechanical switch 960 is labelled in the electrical network 900 for clarity.

The aircraft control system 100 is communicatively coupled to one or more of the electromechanical switches 960, for example using the interface(s) 110. An avionic data bus network (not shown) may be provided in the aircraft and connected to certain electrical components, such as the power sources 908 and 910, electromechanical switches 960, transformers 948 to 958, and other suitable components, that may be used to reconfigure the power distribution in the electrical network 900.

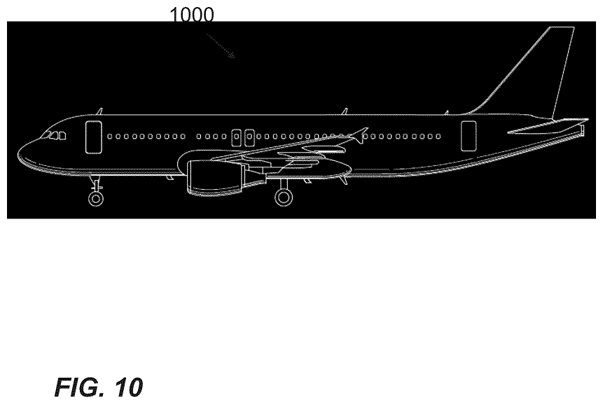

FIG. 10 shows an aircraft 1000 comprising an aircraft control system 100 as described above. In some examples, the aircraft control system 100 may control electrical power distribution for all of the electrical systems in the aircraft 1000. However, in other examples the aircraft control system 100 may control electrical power distribution for a subset of the electrical systems included in the aircraft 1000.

The above embodiments are to be understood as illustrative examples of the invention. Further embodiments of the invention are envisaged. For example, while the state signals 202, 402A, 402B, and 806 have been described as being indicative of an operating state, or condition, of the electrical systems, in other examples, the state signals 202, 402A, 402B, and 806 may alternatively, or additionally, be indicative of a specific operational mode. This may be the case where one or more of the electrical systems, or power source, is capable of operating in any of a plurality of different modes wherein different functions are performed in each operating mode.

In the examples discussed above, the state signals 202 are obtained 302 directly from the electrical systems 204A and 204B and power source 206. However, in other examples, the state signals 202 may be obtained from other sources. For example, the aircraft in which the control system 100 is implemented may include a monitoring system that is configured to monitor states of electrical systems 204A and 204B and/or the power source and to generate state signals 202. This monitoring may be performed passively, by intercepting signals from the electrical systems 204A and 204B or by evaluating the performance of these systems 204A and 204B. Alternatively, or additionally, active monitoring may be performed by requesting electrical systems 204A and 204B, or specific components therein, to generate state signals 202 representative of an operational state of the respective electrical system 204A and 204B.

The state signals 202, 402A, 402B, and 806 may alternatively, or additionally, include an indication of a control state of the aircraft. For example, the state signals 202, 402A, 402B, and 806 may alternatively, or additionally, include signals from one or more controls, such as pilot operated control. Where the pilot, or users, operate controls in the aircraft, these controls may be sent to electrical systems to operate certain functions provided by these electrical systems. In such cases, the state signals 202, 402A, 402B, and 806 are indicative of a control instruction from pilot, or user, and/or the condition of the electrical systems.

The output control data 214 may also be dependent on other data, not discussed above, such as sensor outputs, representing environment and/or aircraft conditions and/or input controls from pilots and/or passengers.

The control characteristics 212, 406A, 406B of the power source 206 may be indicative of a power supply potential of the power source 206, a current power output from the power source 206, or any other relevant characteristics that may influence the manner in which the power source 206 is controlled and used to power the electrical systems 204A and 204B.

The scenario data 804 on which the machine learning classifier 802 is trained may also be dependent on the specific aircraft or electrical network in which the machine learning classifier 802 is to be deployed. The specific control characteristics for certain types of electrical system may vary depending on the specific aircraft and/or electrical network for which the machine learning classifier 802 is to be deployed.

To obtain 304 and 306 the control characteristics 210, 212, 404A, 404B, 406A, 406B, the control module 102 may read the control characteristics 210, 212, 404A, 404B, 406A, 406B from storage 106. For example, the storage 106 may include control characteristic data indicating control characteristics 210, 212, 404A, 404B, 406A, 406B indexed according to electrical system, flight phase status, state signals, or any other suitable conditions for organizing the control characteristics 210, 212, 404A, 404B, 406A, 406B according to the examples described above. In this case, the control characteristic data may include, for each possible combination of state signals and flight phase status, corresponding control characteristics 210, 212, 404A, 404B, 406A, 406B. Alternatively, the control characteristic data may include control characteristics 210, 212, 404A, 404B, 406A, 406B for each possible flight phase, and the control module 102 may modify control characteristics 210, 212, 404A, 404B, 406A, 406B based on the relevant state signals 202, 402A, 402B, and 806.

In other examples, such as those described above with respect to FIGS. 6 and 7, the control characteristics 210, 212, 404A, 404B, 406A, 406B may be determined, or inferred, using a machine learning classifier.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims. It is to be noted that the term “or” as used herein is to be interpreted to mean “and/or”, unless expressly stated otherwise.

1. An aircraft control system configured to control electrical power distribution for a plurality of electrical systems in an aircraft, the aircraft control system comprising a control module that is configured to:
obtain state signals from the plurality of electrical systems and a power source;
obtain data indicative of a control characteristic of each of the plurality of electrical systems, wherein the control characteristic of a said electrical system is dependent on a flight phase status of the aircraft;
obtain data indicative of a control characteristic of the power source;
generate output control data based on the control characteristics of each of the plurality of electrical systems, the control characteristic of the power source, and the state signals; and
control electrical power distribution in the aircraft based on the output control data.

2. The aircraft control system of claim 1, wherein the flight phase status comprises one of a plurality of potential flight phases including a first flight phase and a second, different, flight phase, and
wherein the control characteristic for a said electrical system during the first flight phase is different to the control characteristic for the said electrical system during the second flight phase.

3. The aircraft control system of claim 2, wherein the control characteristic comprises power consumption.

4. The aircraft control system of claim 3, wherein the first flight phase comprises a landing phase, the second flight phase comprises a cruising phase, and wherein:
for at least one of the electrical systems, the power consumption during the landing phase is less than the power consumption during the cruising phase; and/or
for at least one of the electrical systems, the power consumption during the landing phase is more than the power consumption during the cruising phase.

5. The aircraft control system of claim 4, wherein the at least one electrical system, for which the power consumption during the landing phase is less than the power consumption during the cruising phase, comprises a power circuit for a passenger comfort system.

6. The aircraft control system of claim 4, wherein the at least one electrical system, for which the power consumption during the landing phase is more than the power consumption during the cruising phase, comprises a power circuit for a braking control system.

7. The aircraft control system of claim 2, wherein the control characteristic comprises a power supply priority.

8. The aircraft control system of claim 7, wherein the first flight phase comprises a landing phase, the second flight phase comprises a cruising phase, and wherein:
for at least one of the electrical systems, the power supply priority during the landing phase is lower than the power supply priority during the cruising phase; and/or
for at least one of the electrical systems, the power supply priority during the landing phase is higher than the power supply priority during the cruising phase.

9. The aircraft control system of claim 8, wherein the at least one electrical system, for which the power supply priority during the landing phase is lower than the power supply priority during the cruising phase, comprises a power circuit for a passenger comfort system.

10. The aircraft control system of claim 8, wherein the at least one electrical system, for which the power supply priority during the landing phase is higher than the power supply priority during the cruising phase, comprises a power circuit for a braking control system.

11. The aircraft control system of claim 1, wherein the control characteristic of a said electrical system of the plurality of electrical systems is dependent on a condition of the said electrical system and wherein the state signals indicate the condition of the said electrical system.

12. The aircraft control system of claim 1, wherein at least one electrical system of the plurality of electrical systems comprises an integrated power source, and the control characteristic of the at least one electrical system is dependent on a state of the integrated power source, wherein for the at least one electrical system comprising an integrated power source, the control characteristic comprises at least one of:
a measure of power supply potential of the integrated power source; and
a measure of energy capacity of the integrated power source.

13. The aircraft control system of claim 12, wherein controlling electrical power distribution comprises reducing the electrical power supplied to the at least one electrical system comprising an integrated power source when the measure of power supply potential of the integrated power source is indicative of a capability of the integrated power source to satisfy a power consumption of the associated electrical system.

14. The aircraft control system of claim 1, wherein controlling electrical power distribution comprises at least one of:
reducing electrical power supplied to at least one electrical system of the plurality of electrical systems;
increasing electrical power supplied to at least one electrical system of the plurality of electrical systems;
reducing electrical power supplied by the at least one power source; and
increasing electrical power supplied by the at least one power source.

15. The aircraft control system of claim 1, wherein the aircraft control system comprises a machine learning classifier, and wherein generating output control data comprises processing, using the machine learning classifier, the control characteristic of each of the plurality of electrical systems, the control characteristic of the power source, and the state signals.

16. The aircraft control system of claim 15, wherein the control module is configured to:
store the output control data;
after controlling electrical power distribution in the aircraft using the output control data, obtain further state signals from the plurality of electrical systems;
process the further state signals to determine a set of performance indicators;
store the set of performance indicators in association with the output control data; and
tune the machine learning classifier using the stored output control data and the associated set of performance indicators.

17. The aircraft control system of claim 1, wherein the plurality of electrical systems includes any one or more of:
a power circuit for an in-flight entertainment system;
a power circuit for an air conditioning system;
a power circuit for a food preparation system;
a power circuit for a cabin pressurization system;
a power circuit for a flight control system;
a power circuit for a navigation system;
a power circuit for a braking control system;
a power circuit for a landing gear extension and retraction system;
a power circuit for a landing gear health monitoring system;
a power circuit for a fuel monitoring system; and
a power circuit for an engine control system.

18. The aircraft control system of claim 1, wherein the flight phase status of the aircraft comprises any one or more of:
a planning phase;
a take-off phase;
a climbing phase;
a cruise phase;
a descent phase;
an approach phase;
a landing phase;
a braking phase; and
a taxiing phase.

19. An aircraft comprising an aircraft control system configured to control electrical power distribution for a plurality of electrical systems in an aircraft, the aircraft control system comprising a control module that is configured to:
obtain state signals from the plurality of electrical systems and a power source;
obtain data indicative of a control characteristic of each of the plurality of electrical systems, wherein the control characteristic of a said electrical system is dependent on a flight phase status of the aircraft;
obtain data indicative of a control characteristic of the power source;
generate output control data based on the control characteristics of each of the plurality of electrical systems, the control characteristic of the power source, and the state signals; and
control electrical power distribution in the aircraft based on the output control data.

20. A method of controlling power distribution in an aircraft comprising a plurality of electrical systems, the method comprising:
obtaining state signals from the plurality of electrical systems and a power source;
obtaining data indicative of a control characteristic of each of the plurality of electrical systems, wherein the control characteristic of a said electrical system is dependent on a flight phase status of the aircraft;
obtaining data indicative of a control characteristic of the power source;
generating output control data based on the control characteristics of each of the plurality of electrical systems, the control characteristic of the power source, and the state signals; and controlling electrical power distribution in the aircraft based on the output control data.
